(19) United States
(12) Patent Application Publication
(10) Pub. No.: US 2006/0179073 A1
(43) Pub. Date: Aug. 10, 2006

(54) Information management system

(76) Inventor: Shinya Kimura, KOBE-SHI, HYOGO (JP)

Correspondence Address: BIRCH STEWART KOLASCH & BIRCH, PO BOX 747, FALLS CHURCH, VA, 22040-0747, US

(21) Appl. No.: 10/549,308

(22) PCT Filed: Mar. 20, 2003
(86) PCT No.: PCT/JP03/03413

§ 371 Date: Sep. 16, 2005

(51) Int. Cl. G06F 17/00

(52) U.S. Cl. 707/102

(57) ABSTRACT

Provided is an information management system capable of reliably protecting personal data while ensuring the usefulness of the information when data containing personal data are processed. In an information management system (1), processing-object data containing personal data are acquired by an information management apparatus (2), the personal data are extracted from the processing-object data, and the extracted personal data are processed by means of a one-way function to generate a unique code. The personal data contained in the processing-object data are replaced with the unique code to generate primary conversion data, the primary conversion data are transmitted from the information management apparatus (2) to an information center apparatus (4), and they are stored in a data base (5) and used for statistical processing.

### TECHNICAL FIELD

The present invention relates to an information management system for managing information containing personal data.

### BACKGROUND ART

With the development of computerization, a large volume of computerized information has come to be handled in governmental departments, private enterprises, public entities, and the like. Computerized information can be easily processed in the form of accumulation, retrieval, copying, etc., and further, they can be subjected to advanced data processing such as detailed analysis, so that it is highly useful.

Meanwhile, not a few of the above computerized data contain personal data such as individual names, birth dates, addresses, telephone numbers, sexes, family structures, and the like. It is imperative to handle personal data carefully for preventing them from being misused and preventing the infringement of privacy, and it is required to keep them secret as required.

For example, when data of individual attributes are statistically processed, it is inevitable to collect a large volume of information containing personal data, so that a large amount of labor is spent for implementing stringent information management. Studies have been made in various ways for a method of effectively and reliably protecting personal data.

For example, there has been a method in which character strings denoting personal data are all replaced with senseless characters or symbols. In this method, however, personal data are completely lost, so that there is caused a problem that it is no longer possible to distinguish a plurality of data relating to one person from a plurality of data relating to a plurality of persons. This problem could lead to a disadvantage that the number of parent populations comes to be ambiguous in statistical procedures, so that the accuracy of analysis is degraded.

There has been therefore available a method in which only part of a character string denoting personal data is manipulated by simple procedures such as sorting of characters or substitution of other characters. In this method, personal data partly retain a state that the part has had in the beginning, so that it is at least possible to discriminate information relating to one and the same person and information relating to other persons by referring to a plurality of manipulated personal data. In this method, however, regularity can be found when the manipulated personal data are analyzed, so that it can be possibly revealed what manipulations have been applied thereto. When information data that are to be strictly managed such as information on personal health conditions, assets, etc., are handled, the above method cannot be employed due to concerns for security.

When manipulation is applied to personal data as an object to be processed for keeping personal data secret, there has been involved a problem that the usefulness of data is impaired when the manipulation is complicated, or that personal data cannot be reliably protected when the manipulation is simple.

Under the circumstances, there has been hence employed a method in which information containing personal data is encrypted using a password. In this method, however, it is required to take control of the password so that it may not be lost or revealed, and there has been therefore involved a problem that the management burden is heavy. Further, in the method in which a large volume of data are encrypted for storage and decrypted for use, the encryption and decryption are time-consuming, so that there has been a problem the efficiency of information processing is decreased.

### DISCLOSURE OF THE INVENTION

It is an object of the present invention to provide an information management system that is capable of reliably protecting personal data without impairing the usefulness of the information in the processing of the information containing personal data.

For achieving the above object, the first subject matter of the present invention is directed to an information management apparatus for processing data containing personal data,

which comprises personal data extraction means for extracting personal data from processing-object data,

unique code generation means for performing a one-way-function-applied operation on the basis of personal data extracted by said personal data extraction means, to generate a unique code, and

primary conversion data generation means for replacing personal data of said processing-object data with said unique code, to generate primary conversion data.

The second subject matter of the present invention is an information management apparatus as recited in the first subject matter, which further comprises storage means for storing said primary conversion data and said processing-object data in a state in which these data correspond to each other.

The third subject matter of the present invention is an information management apparatus as recited in the first subject matter, wherein said unique code generation means is comprised of a reference character string generation means for generating a reference character string from personal data extracted by said personal data extraction means, and operation means for operating a predetermined operation-object character string by means of said one-way function using said reference character string as a key, to generate said unique code.

The fourth subject matter of the present invention is an information management apparatus as recited in the third subject matter, wherein said operation means is comprised of digit number determination means for determining an operation digit number on the basis of said reference character string, operation-object character string generation means for generating an operation-object character string having said operation digit number and operation implementation means for operating said operation-object character string by means of said one-way function using said reference character string as a key.

The fifth subject matter of the present invention is directed to an information management apparatus as recited in the first subject matter, which further comprises a secondary conversion data generation means for encrypting said primary conversion data to generate secondary conversion data, output means for outputting said secondary conversion data to other apparatus, and storage means for storing said secondary conversion data, said primary conversion data on which said secondary conversion data are based, said processing-object data on which said primary conversion data are based and records of output by said output means in a state in which these data and record correspond to one another when said secondary conversion data is outputted by said output means.

The sixth subject matter of the present invention is an information management system which comprises an information management apparatus for processing data containing personal data and an information center apparatus for managing data processed with said information management apparatus, the information management apparatus and the information center apparatus being connected to each other through a communication line, said information management apparatus comprising personal data extraction means for extracting personal data from processing-object data, unique code generation means for performing an operation using one-way function on the basis of personal data extracted with said personal data extraction means and thereby generating a unique code, primary conversion data generation means for replacing the personal data of said processing-object data with said unique code and thereby generating primary conversion data, secondary conversion data generation means for encrypting said primary conversion data and thereby generating secondary conversion data, output means for outputting said secondary conversion data to said information management apparatus through said communication line, and storage means for storing, when said secondary conversion data are outputted with said output means, said secondary conversion data outputted, said primary conversion data as an original of said secondary conversion data, said processing-object data as an original of said primary conversion data and records of the output made by said output means, in a state in which they correspond to one another, said information center apparatus comprising receiving means for receiving secondary conversion data transmitted from said information management apparatus and decryption means for decrypting secondary conversion data received with said receiving means and thereby generating said primary conversion data.

The seventh subject matter of the present invention is an information management system as recited in the sixth subject matter, wherein said information center apparatus further comprises data storage means for storing primary conversion data generated with said decryption means and processes data stored in said data storage means with using said unique code as a key.

The eighth subject matter of the present invention is an information management system as recited in the seventh subject matter, wherein said information center apparatus detects data containing the same unique code from a plurality of data containing said unique codes stored in said data storage means.

The ninth subject matter of the present invention is a program for causing an information management computer for processing data containing personal data to execute processing comprising the steps of extracting personal data from processing-object data with personal data extraction means, implementing an operation using a one-way function on the basis of the personal data extracted with said personal data extraction means by means of unique code generation means to generate a unique code, and replacing personal data of said processing-object data with said unique code by means of primary conversion data generation means to generate primary conversion data.

The tenth subject matter of the present invention is a program as recited in the nine subject matter, which is for causing the information management computer to execute the processing which further comprises the step of storing said primary conversion data and said processing-object data as an origin of said primary conversion data in storage means in a state in which they correspond to each other.

The eleventh subject matter of the present invention is a program as recited in the ninth subject matter, wherein the step of generating the unique code with said unique code generation means comprises the steps of generating a reference character string from personal data, which are extracted with said personal data extraction means, with a reference character string generation means, and operating a predetermined operation-object character string with said one-way function using said reference character string as a key to generate said unique code.

The twelfth subject matter of the present invention is a program as recited in the eleventh subject matter, wherein the step of generating said unique code with said operation means comprises the steps of determining an operation digit number on the basis of said reference character string with digit number determination means, generating an operation-object character string having said operation digit number with operation-object character string generation means, and operating said operation-object character string on the basis of said one-way function with an operation implementation means using said reference character string as a key.

The thirteenth subject matter of the present invention is a program as recited in the ninth subject matter, which is for causing the information management computer to execute the processing which further comprises the steps of encrypting said primary conversion data with secondary conversion data generation means to generate secondary conversion data, outputting said secondary conversion data to other apparatus with output means, and causing storage means, when said secondary conversion data are outputted with said output means, to store said secondary conversion data outputted, said primary conversion data as an origin of said secondary conversion data, said processing-object data as an origin of said primary conversion data and records of the output by said output means, in a state in which they correspond to one another.

### BRIEF DESCRIPTION OF DRAWINGS

FIG. 1 is a diagram showing the concept of processing in an embodiment of the present invention.

FIG. 2 is a diagram showing the constitution of an information management system in the embodiment of the present invention.

FIG. 3 is a block diagram showing a functional constitution of an information management apparatus shown in FIG. 2.

FIG. 4 is a diagram showing a constitution of a Rezept data to be processed in the embodiment of the present invention. In the description, “Rezept” means a statement of medical treatment fees paid to a medical institution under the medical insurance system.

FIG. 5 is a flow diagram showing the operation of the information management system shown in FIG. 2.

FIG. 6 is a flow diagram showing details of unique code generation processing in the embodiment of the present invention.

FIG. 7 is a diagram showing a specific example for explaining the unique code generation processing in the embodiment of the present invention.

FIG. 8 is a diagram showing another specific example for explaining the unique code generation processing in the embodiment of the present invention.

FIG. 9 is a flow diagram showing details of the processing of transmitting and receiving data in the embodiment of the present invention.

FIG. 10 is a diagram showing an example of a database in which data containing personal data are stored.

FIG. 11 is a diagram showing an example of a database in which data containing unique codes are stored.

### PREFERRED EMBODIMENTS OF THE INVENTION

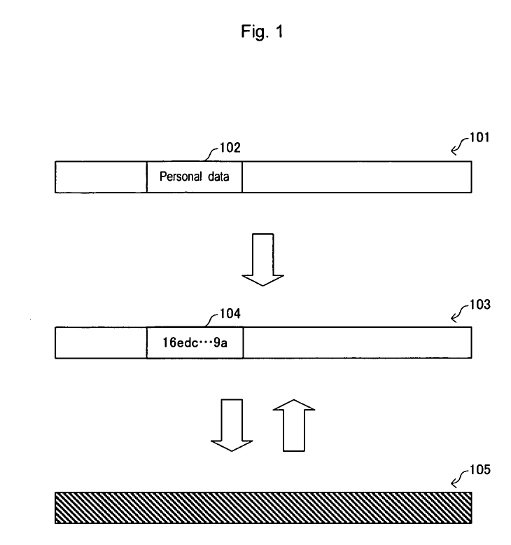

FIG. 1 is a diagram showing an underlying concept of embodiments of the present invention. The present invention addresses information containing personal data as a processing object.

The personal data referred to herein include data which permits identification of a person by itself or in combination with other information and data that can be used or revealed only when consent is given or that is said to be desirably kept secret, such as a personal history (an educational background, a job history and other information showing a history of activities), information showing personal attributes in various organizations, and the like. Specific examples of the personal data are a name, a birth date, a sex, an address, a contact address (a telephone number, a facsimile telephone number, an e-mail address, etc.), data relating to social security or taxes (a social security number, a taxpayer identification number, etc.), data relating to an occupation (a name and address of place of employment, a contact address, a position, responsibilities, etc.), data relating to educational institutions in which a person is, or used to be, enrolled (the name, address and contact address of an educational institution, a year of registration or graduation in/from a school, a student ID number, etc.), data showing personal purchase history (a history of commodity purchase, a policy number of life insurance or damage insurance in which a person takes out a policy, etc.), personal credit data such as a credit card number, an account number in a banking institution, and the like.

Basic data 101 shown in FIG. 1 contain personal data 102 in a state where they are identifiable by a third party. In this embodiment, a unique code 104 is generated on the basis of the personal data 102, and the personal data 102 are replaced with the unique code 104 to generate primary conversion data 103. That is, the primary conversion data 103 are the same as the basic data 101 except that the personal data 102 of the basis data 101 are replaced with the unique code 104.

In this embodiment, further, when the primary conversion data 103 are outputted to other devices, that is, when the primary conversion data 103 are transmitted or received through a communication line or transported via a recording medium in which they are recorded, there are used secondary conversion data 105 generated by encrypting the entire primary conversion data 103 with a predetermined password. When a device receives the secondary conversion data 105, the device decrypts the secondary conversion data 105 with the above password, whereby the primary conversion data 103 can be obtained.

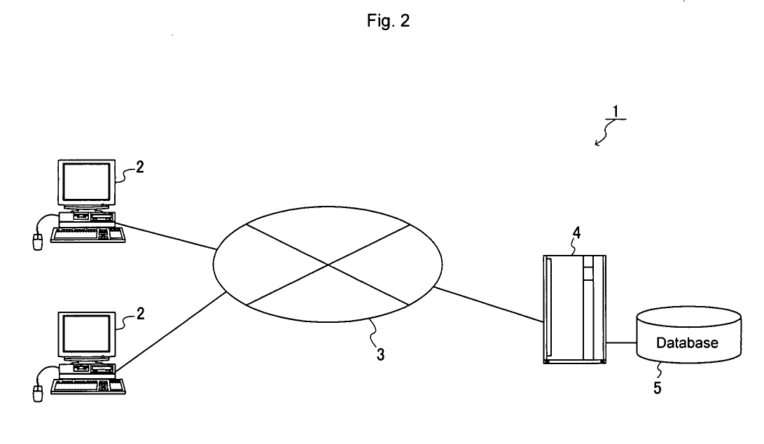

Preferred embodiments of the present invention will be specifically explained in detail below with reference to FIGS. 2 to 11.

FIG. 2 is a diagram showing a constitution of an information management system according to an embodiment of the present invention. An information management system 1 shown in FIG. 2 comprises an information management apparatus 2 and an information center apparatus 4 connected to the information management apparatus 2 through a network 3. While FIG. 2 shows two information management apparatuses 2, it is sufficient to provide at least one information management apparatus 2.

The network 3 includes various communication lines such as a dedicated line, a public telephone line, a satellite communication channel, and the like. The network 3 may be an open network like the Internet or may be a closed network which limited apparatus alone can access. Specific embodiments (type of a line, a bandwidth, a network topology and protocol to be used) of the network 3 shall not be specially limited, and the network 3 may have an embodiment including various server apparatuses, fire wall apparatuses, gateway apparatuses, and the like.

The information management apparatus 2 and the information center apparatus 4 transmit and receive various data, control data, etc., to/from each other through the network 3.

The information center apparatus 4 receives information transmitted from the information management apparatus 2, and when the received information is encrypted information, the information center apparatus 4 decrypts the information. Further, the information center apparatus 4 has a database 5 and causes the database 5 to record the decrypted information, and it also retrieves information recorded in the database 5 to execute processes such as selection, projection and joining.

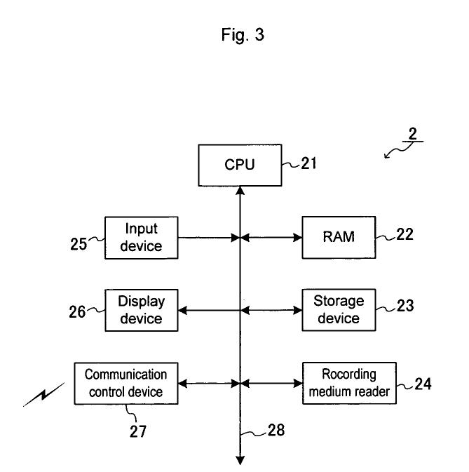

FIG. 3 is a block diagram showing a functional constitution of the information management apparatus 2. As shown in FIG. 3, the information management apparatus 2 has CPU (Central Processing Unit) 21, RAM (Random Access Memory) 22, a storage device 23, a recording medium reader 24, an input device 25, a display device 26 and a communication control device 27, and each unit is connected to a bus 28.

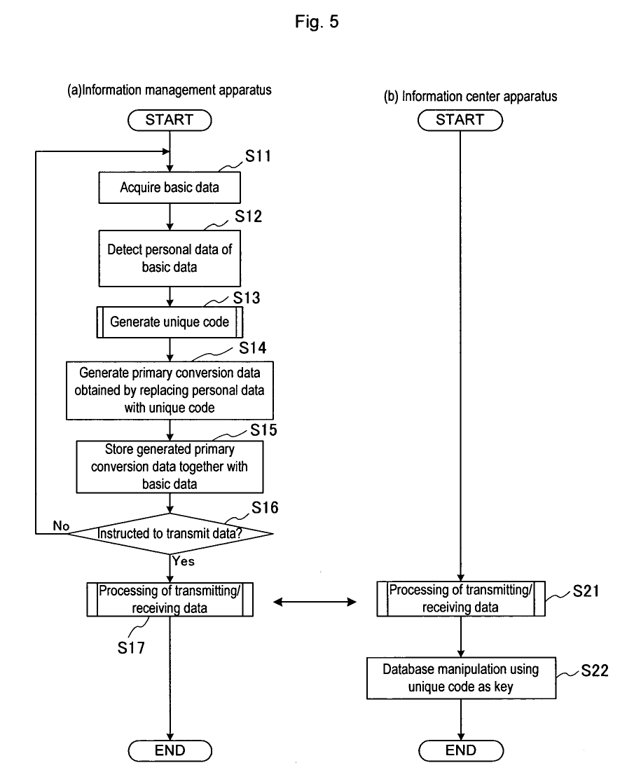

CPU 21 reads out and executes a computer program stored in the storage device 23 on the basis of an instruction inputted by a user with the input device 25 to perform processing shown in FIG. 5. That is, CPU 21 reads out information recorded in a recording medium with the recording medium reader 24 and acquires basic data to generate primary conversion data on the basis of the basic data. Further, CPU 21 encrypts the primary conversion data to generate secondary conversion data and transmits the secondary conversion data to the information center apparatus 4 through the network 3.

RAM 22 tentatively stores computer programs to be executed by CPU 21 and data to be processed during the execution of the computer programs.

The storage device 23 stores the computer programs to be executed by CPU 21 and data to be processed during the execution of the computer programs in a state in which they are readable by CPU 21. The storage device 23 outputs a requested computer program, data, etc., to CPU 21 according to a read request from CPU 21. Further, the storage device 23 stores data according to a write request from CPU 21.

The recording medium reader 24 is a device for reading out information recorded in a portable recording medium such as a magnetic or optical recording medium, a recording medium integrated with a semiconductor memory device, or the like, according to the control by CPU 21.

The input device 25 includes a pointing device such as a mouse, a pen tablet, a touch panel, a digitizer, or the like and an input device such as a keyboard, or the like, and generates an actuating signal according to the operation of the input device to output it to CPU 21.

The display device 26 has a display screen such as CRT (Cathode Ray Tube), LCD (Liquid Crystal Display), or the like, and displays an instruction inputted by the input device 25, a result of processing executed by CPU 21, or the like, on the display screen.

The communication control device 27 is connected to the network 3 and transmits/receives various data through the network 3.

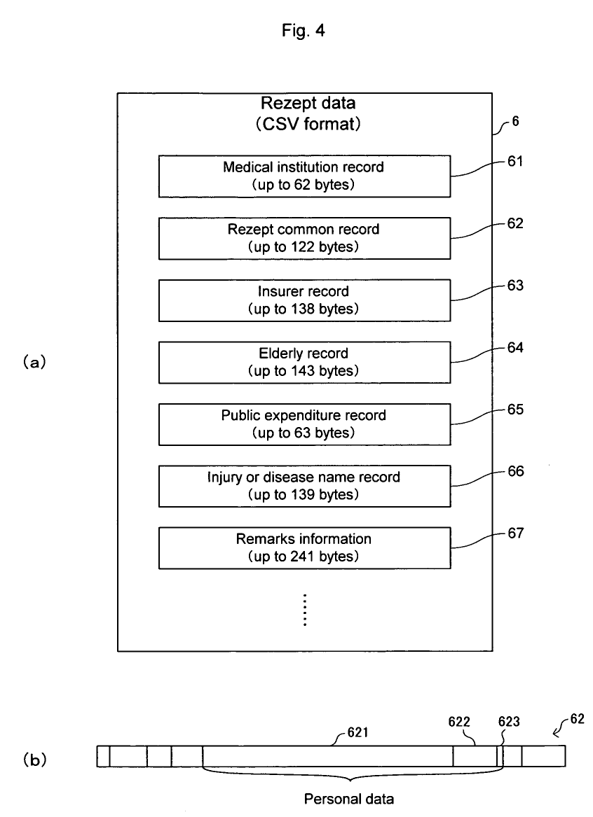

FIG. 4 is a diagram showing a constitution of “Rezept” data as an object to be processed in this embodiment. FIG. 4(a) shows a constitution of the entire Rezept data, and FIG. 4(b) shows a constitution of a portion that particularly contains personal data. While the information management system 1 can process various data, this embodiment will explain the case of processing Rezept data as an example of data containing personal data.

The “Rezept” officially refers to a statement of medical treatment fees that a medical institution prepares and submits to an insurer for receiving medical treatment fees under the health insurance system in Japan. The Rezept has records of various data such as personal data of a patient, data relating to a medical institution where the patent has been medically treated, data showing medical treatment contents, data relating to medical treatment fee amounts, and the like.

Generally, medical treatment fees using the Rezept are billed every month, so that a medical institution uses one Rezept for billing an insurer for medical treatment fees for the medical treatments that have been provided for one patient in one month. When one patient is medically treated in a plurality of medical institutions, the plurality of medical institution prepare and submit Rezept, respectively. For one patient, therefore, a plurality of Rezepts may be submitted per month.

In some medical institutions where data of medical treatments are processed by computerization, there are prepared Rezept data that are finalized data to be recorded in Rezepts, and Rezepts are prepared by printing Rezept data in a specified format.

A Rezept data is constituted, for example, as shown in FIG. 4(a). Incidentally, FIG. 4(a) is at least a diagram showing an example, and not all of Rezepts are constituted as shown in FIG. 4(a).

Rezept data 6 is data in which various pieces of information to be recorded in the Rezept are described in a CSV (Comma Separated Value) format. The Rezept data 6 comprises a medical institution record 61, a Rezept common record 62, an insurer record 63, an elderly record 64, a public expenditure record 65, an injury or disease name record 66 and remarks information 67.

The medical institution record 61 is constituted of up to 62-byte data containing information on a medical institution which has provided a patient with medical treatment, that is, information on a medical institution which prepares a Rezept and other information. Specifically, the medical institution record 61 contains information showing an autonomous body to which the location of the medical institution belongs, a code provided to the medical institution, the name of the medical institution, a course of medical treatment, date of billing medical treatment fees, and the like.

The Rezept common record 62 is constituted of up to 122-byte data mainly containing information on a patient. Specifically, the Rezept common record 62 contains date(s) on which a patient has received medical treatment, the name, birth date and sex of the patient, the proportion of medical treatment fee which the patient is to pay individually, the number of the patient's file, and the like. When the patient is hospitalized, it also contains information such as the date of the hospitalization, a type of a hospital ward, the number of beds, and the like.

The insurer record 63 is constituted of up to 138-byte data containing information on an insurer to which medical treatment fee is billed, the health insurance certificate number of the patient, information on a medical treatment fee amount and a breakdown thereof, and the like.

The elderly record 64 contains various pieces of information for receiving a medical treatment fee from an autonomous body under the system of medical care for senior citizens and is constituted of up to 143-byte data.

The public expenditure record 65 contains various pieces of information necessary for the patient to receive special public financial assistance to a medical treatment fee and is constituted of up to 63-byte data.

The injury or disease name record 66 is constituted of up to 139-byte data containing information on the injury or disease of the patient.

The remarks information 67 is constituted of up to 241-byte data containing a medical treatment record (up to 32 bytes) containing contents of medical treatment that the medical institution has provided for the patient, a medicament record (up to 33 bytes) containing information on medicaments used, a special-apparatus record (up to 86 bytes) containing information on an apparatus used, and a comment record (up to 90 bytes) containing information such as comments, etc., as additional information on contents of the medical treatment.

As shown in FIG. 4(b), the Rezept common record 62 contains a name 621 (up to 40 bytes), a birth date 622 (7 bytes) and a sex code 623 (1 byte) which constitute personal data of a patient. The sex code refers to a code that is determined beforehand as a code for expressing a sex. In this embodiment, a male is expressed by “1”, and a female is expressed by “2”.

The operation of the information management system 1 will be explained below.

FIG. 5 is a flow diagram showing the operation of the information management system shown in FIG. 2. Particularly, FIG. 5(a) shows the operation of the information management apparatus 2, and FIG. 5(b) shows the operation of the information center apparatus 4.

In step S11 (FIG. 5(a)), the recording medium reader 24 reads out information from a recording medium, so that the information management apparatus 2 acquires basic data (Rezept data) as a processing object.

In step S12, the information management apparatus 2 detects personal data in the basic data. In step S13, then, the information management apparatus 2 executes processing to generate a unique code on the basis of the personal data detected in step S12.

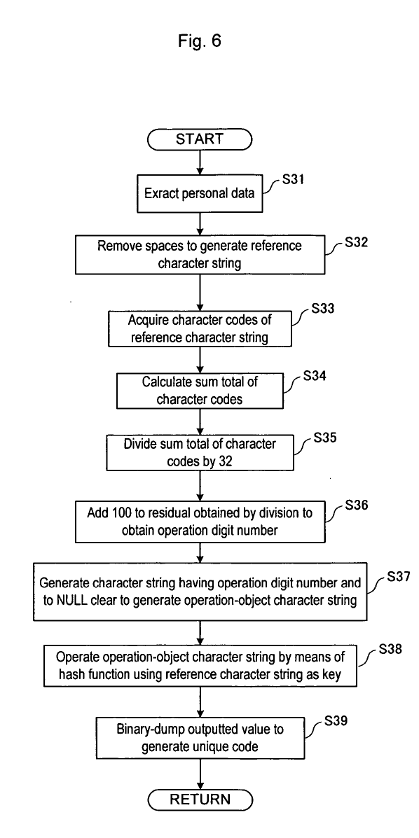

The unique code generation processing in step S13 will be explained later with reference to FIG. 6.

After generation of the unique code, the information management apparatus 2 in step S14 reproduces basic data and replaces the personal data in the reproduced basic data with the unique code to generate primary conversion data. In step S15, the information management apparatus 2 causes the storage device 23 to store the primary conversion data generated in step S14 together with the basic data, and proceeds to step S16 to receive an instruction to be inputted from the input device 25.

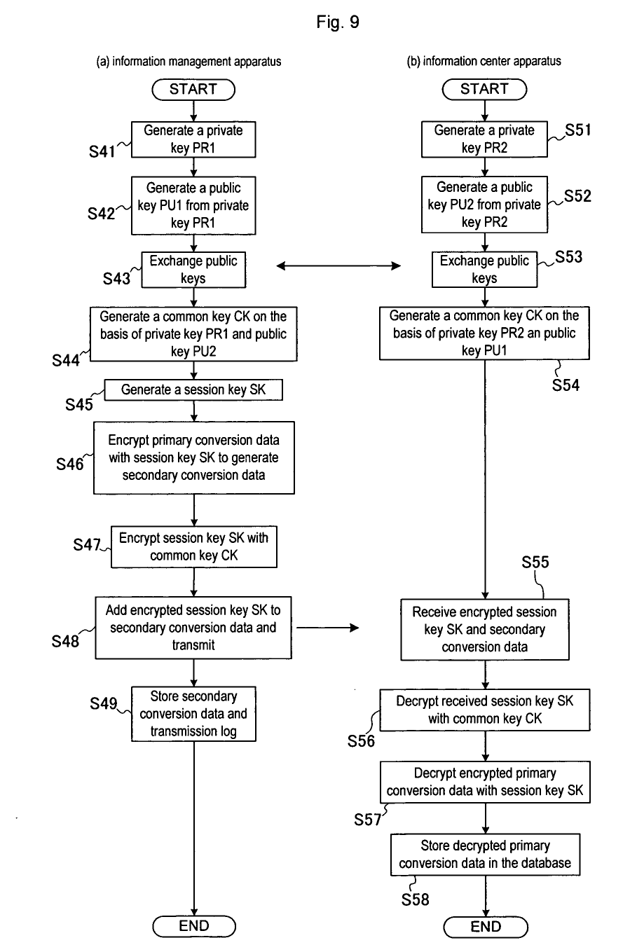

In step S16, when an instruction to transmit data to the information center apparatus 4 is inputted from the input device 25, the information management apparatus 2 proceeds to step S17 and executes processing to transmit data to the information center apparatus 4. The processing of transmitting/receiving data in step S17 will be explained later with reference to FIG. 9(a).

After the processing of transmitting/receiving data in step S17, the information management apparatus 2 ends the operation.

Further, when no instruction is inputted from the input device 25, the information management apparatus 2 proceeds back to step S11.

Upon the start of the processing of transmitting/receiving data by the information management apparatus 2 in step S17, the information center apparatus 4 proceeds to step S21 (FIG. 5(b)) to execute the processing of transmitting/receiving data. The processing of transmitting/receiving data in step S21 will be explained later with reference to FIG. 9(b).

After the processing of transmitting/receiving data, the information center apparatus 4 proceeds to step S22 and executes the processing of operating the database by means of the unique code as a key with regard to information received in step S21.

FIG. 6 is a flow diagram that more fully shows the processing of generating the unique code shown in step S13 in FIG. 5(a).

In step S31, the information management apparatus 2 extracts personal data from the basic data. In step S32, the information management apparatus 2 removes half size spaces and full size spaces from the extracted personal data and prepares a reference character string.

In subsequent step S33, the information management apparatus 2 acquires character codes with respect to all of characters constituting the reference character string. In step S33, there can be used various character code sets such as character code sets of ASCII code, Unicode, JIS code, shift JIS code, and the like.

In step S34, the information management apparatus 2 calculates a total of character codes of all of characters constituting the reference character string. In subsequent step S35, the information management apparatus 2 divides the sum total of the character codes determined in step S34 by the numeric “32”, to determine a quotient and a remainder. The information management apparatus 2 proceeds to step S36 and adds 100 to the determined remainder to obtain an operation digit number.

By the processing through the above steps S33 to S36, the operation digit number is determined to be one of 100 to 131. The range of those values which the operation digit number can have is determined depending upon a divisor (division) used in step S35. When the divisor (division) is, for example, 50, the operation digit number is determined in the range of 100 to 149. When the divisor (division) is 10, the operation digit number is determined in the range of 100 to 109. That is, when the divisor (division) is an integer n, the operation digit number is determined in the range of 100 to {100+(n-1)}. This embodiment uses 32 as only an example of the divisor (division).

Then, the information management apparatus 2 proceeds to step S37, and it generates a character string having the same digit number as that of the operation digit number and performs NULL clear, whereby there is generated a character string which has the same digit number as that of the operation digit number and in which all the digits are “0 (zero)”. The character string generated in this step S37 is used as an operation-object character string.

In step S38, the information management apparatus 2 performs an operation on the operation-object character string on the basis of the one-way hash function by means of the reference character string as a key. After completion of the operation in step S38, the information management apparatus 2 proceeds to step S39, binary-dumps the operation result to generate a character string. The generated character string becomes a unique code. It is because the result of the operation using the hash function may contain a control code that the binary dump is performed in step S39.

In the unique code generation processing shown in FIG. 6, the operation digit number is determined on the basis of character code of the reference character string obtained by removing spaces from the personal data, so that when the reference character string differs even by one character, the operation digit number differs. Generally, it has been made clear that in an operation using the hash function, an operation result is greatly affected by a change in an initial value. When the operation digit number differs even slightly, therefore, the operation result comes to be extremely different. Further, in the unique code generation processing shown in FIG. 6, the operation is performed by means of the reference character string as a key, so that the reference character string differs even by one character, the operation result is caused to have a far greater difference.

For example, when a unique code is generated on the basis of a name, a birth date and a sex, and if data of one of the name, birth date and sex differ by one character, an entirely different unique code is generated. Therefore, the probability of generating an identical unique code from personal data of a plurality of different persons is almost zero and negligible.

Further, one looks at the thus-generated unique code itself as a meaningless character string, so that it is not possible to discover any regularity even when a number of unique codes are analyzed. It is hence substantially impossible to obtain personal data by operating the unique code. Nor is it possible to determine whether the unique code is generated by using a name alone as a reference character string or whether it is generated from a reference character string containing a name and a birth date.

As described above, while the unique code is generated on the basis of personal data, there is no means of getting at personal data from the unique code itself, so that there is no possibility of personal data being revealed so long as the primary conversion data are simply used.

In the processing shown in FIG. 6, further, the unique code is generated after spaces are removed from the personal data, so that a difference in a descriptive method such as a method of using a space, etc., can be also addressed. In step S32 in FIG. 6, full size and half size spaces are removed. For example, when capital letters and small letters of the alphabet are included in the personal data, however, there may be performed the processing of converting all alphabetical letters to small letters.

Further, a plurality of unique codes can be intentionally generated from the personal data of one and the same person. That is, a unique code generated using a name and birth date as a reference character string and a unique code generated using a name, birth date and sex as a reference character string come to differ from each other. Therefore, when the correspondence relationship between personal data and the unique code generated on the basis of the personal data was revealed with regard to a particular person, the content of the reference character string would be changed to generate another unique code, so that it would be hence possible to prevent the personal data from being further revealed. Further, when different unique codes are generated as required depending upon the morphology of the basic data or the way of use of the unique codes, the processing rate of unique code generation processing can be increased, or the complexity of the unique code(s) can be further increased, so that the unique codes can be efficiently used.

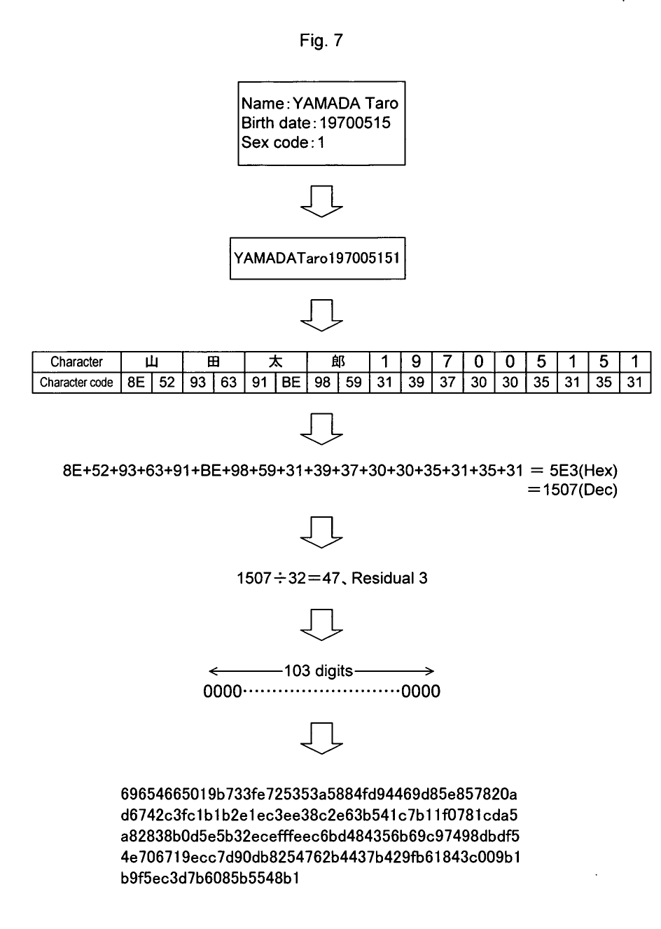

FIG. 7 is a diagram showing a specific example for explaining the unique code generation processing shown in FIG. 6. In the example in FIG. 7, a unique code is generated from personal data of a male named YAMADA Taro having a birth date of May 15, 1970.

The personal data that the information management apparatus 2 extracts consists of a name “YAMADA Taro”, the birth date of “19700515” and a sex code of “1”. The information management apparatus 2 removes full size and half size spaces, to prepare the reference character string of “YAMADATaro197005151”. The reference character string contains the Japanese-language person's name having four “kanji” (Chinese-origin) character letters, so that the information management apparatus 2 acquires character codes from a Japanese-language kanji character code set such as the shift JIS character code set, or the like. In the Japanese character code set, kanji characters are handled as a 2-byte letter each, so that a 2-byte character code is obtained from each of the four kanji characters. Further, in the above character code set for the Japanese language, a half size figure is handled as a 1-byte letter, so that a 1-byte character code is obtained from each of the nine letters of “197005151”. Accordingly, 17-byte character codes are obtained from the reference character string of “YAMADATaro197005151”.

Then, the information management apparatus 2 sums up the character codes of the reference character string. As shown in FIG. 7, the information management apparatus 2 performs the operation of “8E+52+93+63+91+BE+98+59+31+39+37+30+30+35+31+35+31=5E3 (hexadecimal notation)” to determine a sum total “5E3” of the character codes. “5E3” represents “1507” when depicted by decimal notation. Then, the information management apparatus 2 divides the sum total “1507” of the character codes by “32”, to determine a quotient of “47” and a residual of “3”. The operation digit number is determined to be 103 digits by adding “100” to the residual of “3”. Then, the information management apparatus 2 generates a 103-digit operation-object character string of which all the digits are constituted of “0 (zero)”, and performs the operation based on the hash function using the reference character string of “YAMADATaro197005151”. The operation result is binary-dumped to generate, for example, a unique code of “69654665019b733fe725353a5884fd94469d85e857820ad6742c3fc1b1b2e1ec3ee38c2e63b 541c7b11f0781cda5a82838b0d5e5b32ecefffeec6bd484356b69c97498dbdf54e706719ecc7d 90db8254762b4437b429fb61843c009b1b9f5ec3d7b6085b5548b1”. It should be noted that this unique code is obtained by partly modifying the unique code actually obtained on the basis of the above reference character string, in consideration of security.

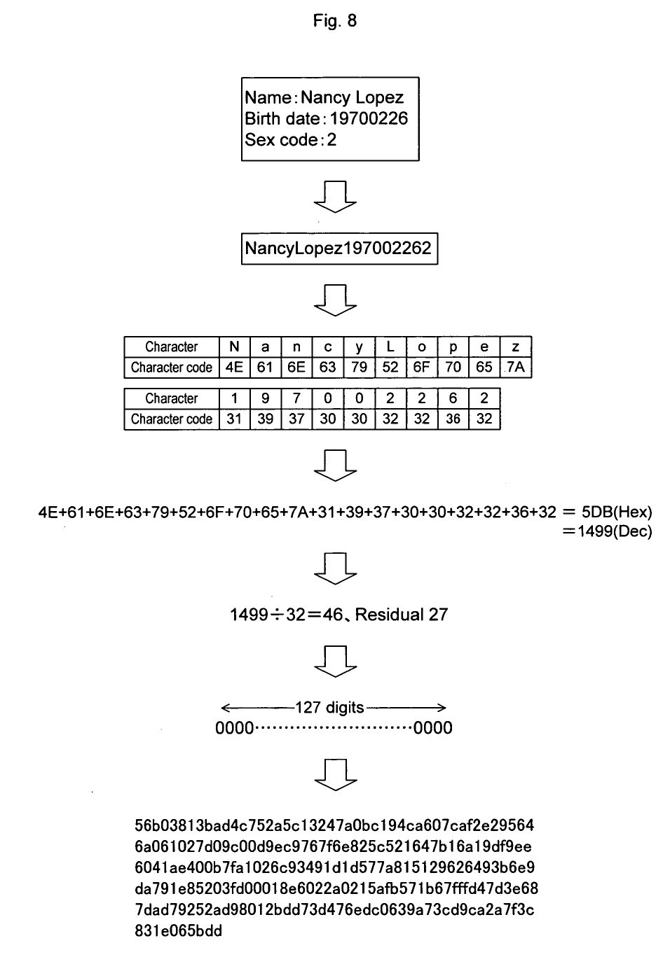

FIG. 8 is a diagram showing another specific example for explaining the unique code generation processing shown in FIG. 6. In the example shown in FIG. 8, a unique code is generated from personal data of a woman named Nancy Lopez having a birth date of Feb. 26, 1970.

The personal data extracted by the information management apparatus 2 includes a name “Nancy Lopez”, the birth date of “19700226” and a sex code of “2”. The information management apparatus 2 removes half size and full size spaces, to prepare a reference character string of “NancyLopez197002262”. In the various character code sets, half size alphabetic characters and figures are handled as a 1-byte character each, so that 19-byte character codes are obtained from the reference character string of “NancyLopez197002262”.

Then, the information management apparatus 2 sums up the character codes of the reference character string. As shown in FIG. 8, the information management apparatus 2 performs the operation of “4E+61+6E+63+79+52+6F+70+65+7A+31+39+37+30+30+32+32+36+32 =5DB (hexadecimal notation)” to determine a sum total “5DB” of the character codes. “5DB” represents “1499” when depicted by decimal notation. Then, the information management apparatus 2 divides the sum total “1499” of the character codes by “32”, to determine a quotient of “46” and a residual of “27”. The operation digit number is determined to be 127 digits by adding “100” to the residual of “27”. Then, the information management apparatus 2 generates a 127-digit operation-object character string of which all the digits are constituted of “0 (zero)”, and performs the operation based on the hash function using the reference character string of “NancyLopez197002262” as a key. The operation result is binary-dumped to generate, for example, a unique code of “56b03813bad4c752a5c13247a0bc194ca607caf2e295646a061027d09c00d9ec9767f6e825c 521647b16a19df9ee6041ae400b7fa1026c93491d1d577a815129626493b6e9da791e85203fd 00018e6022a0215afb571b67fffd47d3e687dad79252ad98012bdd73d476edc0639a73cd9ca2 a7f3c831e065bdd”. It should be noted that this unique code is obtained by partly modifying the unique code actually obtained on the basis of the above reference character string, in consideration of security.

FIG. 9 is a flow diagram showing more details of the processing of transmitting/receiving data in the embodiment of the present invention. FIG. 9(a) shows the processing that the information management apparatus 2 performs in step S17 in FIG. 5(a), and FIG. 9(b) shows the processing that the information center apparatus 4 performs in step S21 in FIG. 5(b).

In the processing of transmitting/receiving data shown in FIG. 9, public-key exchange according to the DH (Diffie-Hellman) technology is implemented, and primary conversion data are transmitted and received.

In step S41 (FIG. 9(a)), the information management apparatus 2 uses, for example, a random number to generate a private key PR1. In step S42, the information management apparatus 2 uses a predetermined operational expression to generate a public key PU1 from the private key PR1. In step S43, the information management apparatus 2 transmits the public key PU1 to the information center apparatus 4, and receives a public key PU2 from the information center apparatus 4, through the network 3.

On the other hand, in step S51 (FIG. 9(b)), the information center apparatus 4 generates a private key PR2 using a random number for example, and in step S52, the information center apparatus 4 uses a predetermined operational expression to generate a public key PU2 from the private key PR2. In step S53, the information center apparatus 4 transmits the public key PU2 to the information management apparatus 2, and receives the public key PU1 from the information management apparatus 2, through the net work 3.

After the processing in the above steps S41 to S43 and the above steps S51 to S53, each of the information management apparatus 2 and the information center apparatus 4 has the private key that it has generated by itself and the public key that the other has generated. The processing shown in FIG. 5 may be implemented after completion of the processing in the above steps S41 to S43 and the above steps S51 to S53 between the information management apparatus 2 and the information center apparatus 4. That is, there may be employed a constitution wherein each of the information management apparatus 2 and the information center apparatus 4 has the private key that it has generated by itself and the public key that the other has generated prior to the implementation of the processing in FIG. 5. In this case, the public key PU1 and the public key PU2 may be transmitted/received through the network 3, or they may be inputted to the information management apparatus 2 and the information center apparatus 4, respectively, by means of input from the input device 25, or the like or from a portable recording medium.

In step S44 (FIG. 9(a)), the information management apparatus 2 generates a common key CK on the basis of the private key PR1 that it has generated by itself and the public key PU2 received from the information center apparatus 4.

In step S45, the information management apparatus 2 generates a session key SK. In the subsequent step S46, the information management apparatus 2 encrypts primary conversion data by means of the session key SK thereby to generate secondary conversion data.

Further, the information management apparatus 2 proceeds to step S47 and encrypts the session key SK by means of the common key CK, and in step S48, the information management apparatus 2 adds the encrypted session key SK to the secondary conversion data and transmits them to the information center apparatus 4.

Then, in step S49, the information management apparatus 2 prepares a transmission log showing the result of transmission to the information center apparatus 4, stores the secondary conversion data and the transmission log in the storage device 23 in a state in which they are correlated with the basic data and the primary conversion data stored in the storage device 23, and ends the processing.

On the other hand, in step S55 (FIG. 9(b)), the information center apparatus 4 receives the encrypted session key SK and the secondary conversion data. In the subsequent step S56, the information center apparatus 4 decrypts the received session key SK by means of the common key CK generated in step S54, and in step S57, it decrypts the secondary conversion data by means of the decrypted session key SK, to obtain the primary conversion data.

In step S58, the information center apparatus 4 registers the primary conversion data obtained in step S57 in the database 5 and ends the processing.

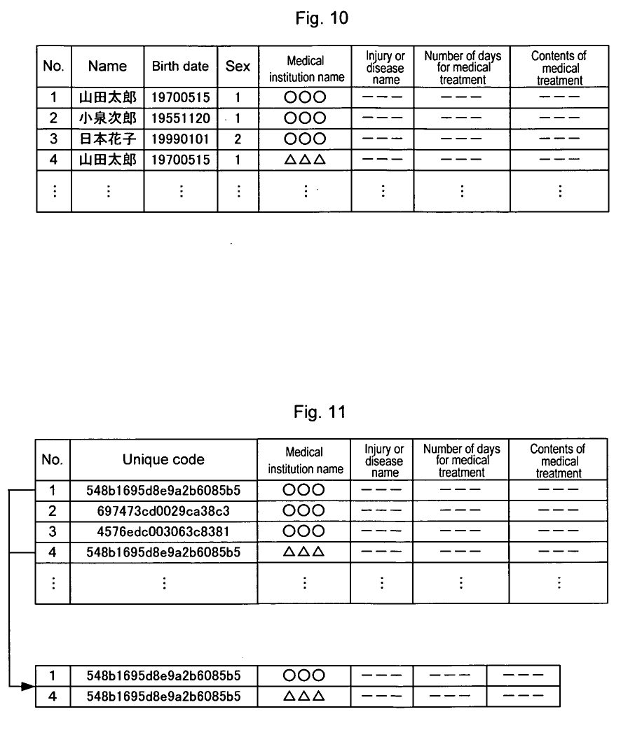

FIG. 10 is a diagram showing an example of a database in which data including personal data are stored. The database shown in FIG. 10 is for storing a record including item data of a name, birth date and sex code of a person, a name of a medical institution, an injury or disease name, the number of days for medical treatment and contents of medical treatment, and it has a plurality of records stored therein with regard to a plurality of persons.

When data containing personal data are stored in a database as described above, database manipulations such as selection, projection, combination, etc., are performed using personal data as a key, and data can be extracted for respective persons. In a database having personal data stored therein, however, it is required to take measures for protecting personal data.

FIG. 11 shows an example of records to be stored in the database shown in FIG. 10, in which personal data is replaced with primary conversion data containing unique codes.

In the database shown in FIG. 11, a plurality of records containing unique codes is stored. The database shown in FIG. 11 contains no personal data, so that it is not required to take any special measures for protecting personal data.

In the database shown in FIG. 11, further, data can be manipulated for each person by means of the unique code as a key. For example, as shown in FIG. 11, the manipulation for selection is carried out by means of a unique code of “548b1695d8e9a2b6085b5” as a key, two records such as No. 1 and No. 4 records are extracted. It is seen that the extracted two records relate to one and the same person since the unique codes are the same as each other. Even when the database shown in FIG. 10 is replaced with the database shown in FIG. 11, therefore, the easiness in retrieval of information is not impaired.

In this embodiment, there are used the primary conversion data in which personal data is replaced with the unique code as described above, so that the personal data can be reliably protected without impairing the usefulness of the information.

As described above, according to the information management system 1 in this embodiment, processing-object data containing personal data are not directly stored in a database. Instead thereof, a unique code is generated from personal data of a processing-object data (basic data), there are generated primary conversion data in which the personal data is replaced with a unique code, and the primary conversion data are stored in the database 5 and used for statistical processing. The unique code is generated from a reference character string obtained by removing spaces from personal data, by an operation using a one-way hash function, so that it is almost impossible to obtain the original personal data by a reverse operation. In the process of processing the primary conversion data, therefore, there is no apprehension of personal data being revealed.

Further, due to a characteristic feature that the operation result of the one-way hash function is extremely influenced by a change in an initial value, there are generated unique codes that can be said to be necessarily unlike and remarkably different when basic character strings differ from one another, that is, different personal data are used. That is, the possibility of identical unique codes being generated from personal data of different persons is very low and negligible, and the usefulness of primary conversion data can be maintained at a high level. Further, since the unique code is generated by determining an operation digit number on the basis of a basic character string and operating an operation-object character string having the above operation digit number by means of the basic character string as a key, remarkably different unique codes are generated when basic character strings differ from one another, so that the possibility of identical unique codes being generated from different personal data is further decreased and that the usefulness of primary conversion data can be maintained at a far higher level.

Like personal data, therefore, the unique code comes to have a unique value for each individual person, so that it can be used for retrieval and extraction of a number of data containing unique codes for each individual person. The primary conversion data containing unique codes in place of personal data are as useful as data containing personal data as described above, so that they can be used for statistical processing. When data containing personal data are processed, the use of the above primary conversion data can reliably keep the personal data secret and protect them without impairing the usefulness of the information. In the information management system 1, the information management apparatus 2 can efficiently generate primary conversion data from basic data.

Further, when the information management apparatus 2 generates primary conversion data from basic data, it causes the storage device 23 to store the primary conversion data and the original basic data in a state in which they are correlated with each other. Further, when the information management apparatus 2 generates secondary conversion data from the primary conversion data and transmits the secondary conversion data to the information center apparatus 4, it causes the storage device 23 to store the secondary conversion data, the primary conversion data as an origin of the secondary conversion data, the basic data that is an origin of the primary conversion data and a transmitting record in a state in which these are correlated with one another. When the generation of the primary conversion data, the generation of the secondary conversion data and information showing a transmission history in the information management apparatus 2 are stored, therefore, the flow of personal data can be reliably controlled.

When primary conversion data are transmitted from the information management apparatus 2 to the information center apparatus 4, the exchange of keys according to the DH technology is implemented, the primary conversion data are encrypted to generate secondary conversion data, and the generated secondary conversion data are transmitted through the network 3. The security can be also ensured reliably during the transmission of information through the network 3. Further, even if the primary conversion data should be revealed to a third party, there is no possibility of personal data being revealed, so that high reliability can be secured.

Further, the information center apparatus 4 stores the primary conversion data received from the information management apparatus 2 in the database 5 and can implement the processing of retrieval or the like by means of the unique code as a key with regard to a plurality of primary conversion data stored in the database 5. For example, there can be implemented the processing of so-called name-identification to extract primary conversion data containing one and the same unique code, whereby the information center apparatus 4 can perform accurate statistical processing in a state completely free of any possibility of revealing personal data.

While the above embodiment explains an example in which Rezept data are used as processing-object data of the information management system 1, the present invention shall not be limited thereto. For example, the present invention can be applied to the processing of data with regard to account numbers, account holders' names, deposit balances or transactions in a banking institution, and can be also applied to the processing of data containing names of pupils or students and records of learning results in an educational institution.

While the above embodiment has a constitution in which the recording medium reader 24 is used when the information management apparatus 2 acquires a basic data, the present invention shall not be limited thereto, and there may be employed a constitution in which the basic data are acquired by inputting from the input device 25. Further, the information management apparatus 2 may have a constitution in which a recording medium reading/writing device capable of writing information to a portable recording medium is provided in place of the recording medium reader 24, and the information center apparatus 4 may have a constitution having a reading device for reading out information from the potable recording medium to which information is written by the information management apparatus 2. This case does not use the network 3 when secondary conversion data are transmitted from the information management apparatus 2 to the information center apparatus 4, and there can be instead used a method in which the secondary conversion data are written in the portable recording medium with the recording medium reading/writing device of the information management apparatus 2 and the secondary conversion data written in the portable recording medium are read out by means of the reading device of the information center apparatus 4.

The constitution of the above embodiment may be changed or modified in some other points. That is, the above embodiment is at least an example and shall not limit the scope of the present invention.

### INDUSTRIAL UTILITY

As is clear from the above explanation, the following effects can be brought about according to the present invention.

(1) According to the first subject matter of the present invention, in the information management apparatus for processing data containing personal data, personal data extraction means extracts the personal data from processing-object data, a unique code generation means generates a unique code from the personal data extracted by means of the personal data extraction means by implementing an operation using a one-way function, and primary conversion data generation means replaces the personal data of the processing-object data with the unique code to generate primary conversion data. It is almost impossible to get at the original personal data from the thus-obtained unique code even by implementing a reverse operation, and different unique codes are generated from personal data of different persons to such an extent that the unique codes can be said to be always and necessarily different. Primary conversion data containing unique codes in place of personal data therefore have usefulness equivalent to that of data containing personal data and can be used for statistical processing. And, when data containing personal data are processed, the use of these primary conversion data can reliably keep the personal data secret and protect them without impairing the usefulness of the information. And, according to the first subject matter of the present invention, the above primary conversion data can be efficiently generated.

(2) According to the second subject matter of the present invention, in the information management apparatus of the first subject matter of the present invention, the primary conversion data and the processing-object data as an origin of the primary conversion data are stored in storage means in a state in which they are correlated with each other. In the information management apparatus, therefore, the processing-object data containing personal data and the primary conversion data containing the unique code can be stored.

(3) According to the third subject matter of the present invention, in the information management apparatus of the first subject matter of the present invention, the unique code generation means generates a reference character string from the personal data, which is extracted by means of the personal data extraction means, and operation means operates a predetermined operation-object character string on the basis of a one-way function by means of the reference character string as a key to generate a unique code. Therefore, when reference character strings differ from one another, that is, when personal data of different persons are used, there are generated unique codes that have such differences that they can be said to be always different. That is, the possibility of identical unique codes being generated from personal data of different persons is negligible, and the usefulness of the primary conversion data can be maintained at a high level.

(4) According to the fourth subject matter of the present invention, in the information management apparatus of the third subject matter of the present invention, the operation means determines the operation digit number on the basis of the reference character string by means of the digit number determination means, generates the operation-object character string having an operation digit number by means of the operation-object character string generation means, and operates the operation-object character string on the basis of the one-way function by means of the reference character string as a key by operation implementation means. Therefore, when reference character strings differ, remarkably different unique codes are generated, so that the possibility of identical unique codes from different personal data comes to be far lower and that the usefulness of the primary conversion data can be maintained at far higher level.

(5) According to the fifth subject matter of the present invention, in the information management apparatus of the first subject matter of the present invention, the secondary conversion data generation means encrypts the primary conversion data to generate the secondary conversion data, the output means outputs the second conversion data to other apparatus, and when the output means outputs the secondary conversion data, the outputted secondary conversion data, the primary conversion data as an origin of the secondary conversion data, the processing-object data as an origin of the primary conversion data and the records of output from the output means are stored in the storage means in a state in which they are correlated with one another. In the information management apparatus, therefore, the processing-object data containing personal data, the primary conversion data containing the unique code, the secondary conversion data and the records of transmitting the secondary conversion data can be reliably stored.

(6) According to the sixth subject matter of the present invention, in the information management system wherein the information management apparatus for processing data containing personal data and the information center apparatus for managing data processed by the information management apparatus are connected via a communication line, the information management apparatus extracts personal data from processing-object data by means of the personal data extraction means, performs an operation using a one-way function on the basis of the personal data extracted by the personal data extraction means by means of the unique code generation means to generate a unique code, replaces the personal data of the processing-object data with the unique code by means of the primary conversion data generation means to generate primary conversion data, encrypts the primary conversion data by means of the secondary conversion data generation means to generate secondary conversion data, and outputs the generated secondary conversion data to the information management apparatus by means of the output means through the communication line, and when the output means outputs the secondary conversion data, the information management apparatus stores the outputted secondary conversion data, the primary conversion data as an origin of the secondary conversion data, the processing-object data as an origin of the primary conversion data and records of the output from the output means in storage means in a state in which they are correlated with one another. Further, the information center apparatus receives the secondary conversion data transmitted from the information management apparatus by receiving means and decrypts the secondary conversion data, which are received by the receiving means, by means of decryption means to generate the primary conversion data. Therefore, in addition to the effect achieved by the first subject matter of the present invention, the primary conversion data are encrypted and then transmitted from the information management apparatus to the information center apparatus, which can ensure reliability in security. Further, the primary conversion data alone are transmitted to the information center apparatus that is another apparatus different from the information management apparatus, so that there can be removed the possibility of personal data being revealed during the transmission of information data to the information center apparatus and during the course of processing of the information in the information center apparatus.

In the seventh subject matter of the present invention, the information center apparatus in the information management system of the sixth subject matter of the present invention further has data storage means for storing the primary conversion data generated by the decryption means, and processes data stored in the data storage means by means of the unique code as a key. Therefore, primary conversion data containing no personal data are stored in the data storage means and various statistical processing operations can be performed using the data storage means. There can be therefore carried out accurate data processing equivalent to that in the case of using data containing personal data while reliably protecting the personal data.

(8) In the eighth subject matter of the present invention, the information center apparatus in the information management system of the seventh subject matter of the present invention detects data containing identical unique codes from a plurality of data containing unique codes stored in the data storage means. That is, like the processing of detection in a plurality of data containing personal data by means of personal data as a key, retrieval is performed with regard to a plurality of primary conversion data containing no personal data by means of a unique code as a key. Therefore, data can be processed without using personal data in a state in which data of one person are distinguishable from data of another person.

(9) According to the ninth subject matter of the present invention, there can be obtained the same effect as that of the above first subject matter of the present invention.

(10) According to the tenth subject matter of the present invention, there can be obtained the same effect as that of the above second subject matter of the present invention.

(11) According to the eleventh subject matter of the present invention, there can be obtained the same effect as that of the third subject matter of the present invention.

(12) According to the twelfth subject matter of the present invention, there can be obtained the same effect as that of the above fourth subject matter of the present invention.

(13) According to the thirteenth subject matter of the present invention, there can be obtained the same effect as that of the above fifth subject matter of the present invention.

1. An information management apparatus for processing data containing personal data comprising:
personal data extraction means for extracting personal data from processing-object data;
unique code generation means for performing an operation using one-way function on the basis of personal data extracted by said personal data extraction means, to generate a unique code; and
primary conversion data generation means for replacing personal data of said processing-object data with said unique code, to generate primary conversion data.

2. An information management apparatus as recited in claim 1, which further comprises storage means for storing said primary conversion data and said processing-object data on which said primary conversion data are based in a state in which these data are correlated with each other.

3. An information management apparatus as recited in claim 1, wherein said unique code generation means comprises a reference character string generation means for generating a reference character string from personal data extracted by said personal data extraction means, and operation means for operating a predetermined processing-object character string by means of said one-way function using said reference character string as a key, to generate said unique code.

4. An information management apparatus as recited in claim 3, wherein said operation means comprises digit number determination means for determining an operation digit number on the basis of said reference character string, processing-object character string generation means for generating an processing-object character string having said operation digit number and operation execution means for operating said processing-object character string by means of said one-way function using said reference character string as a key.

5. An information management apparatus as recited in claim 1, which further comprises a secondary conversion data generation means for encrypting said primary conversion data to generate secondary conversion data, output means for outputting said secondary conversion data to other apparatus, and storage means for storing said outputted secondary conversion data, said primary conversion data on which said secondary conversion data are based, said processing-object data on which said primary conversion data are based and records of output from said output means in a state in which these data and records are correlated with one another when said secondary conversion data are outputted from said output means.

6. An information management system which comprises an information management apparatus for processing data containing personal data and an information center apparatus for managing data processed with said information management apparatus, the information management apparatus and the information center apparatus being connected to each other through a communication line;
said information management apparatus comprising:
personal data extraction means for extracting personal data from processing-object data;
unique code generation means for performing an operation using one-way function on the basis of personal data extracted by said personal data extraction means to generate a unique code;
primary conversion data generation means for replacing the personal data of said processing-object data with said unique code to generate primary conversion data;
secondary conversion data generation means for encrypting said primary conversion data to generate secondary conversion data;
output means for outputting said secondary conversion data to said information management apparatus through said communication line; and
storage means for storing, when said secondary conversion data are outputted from said output means, said outputted secondary conversion data, said primary conversion data as an original of said secondary conversion data, said processing-object data as an original of said primary conversion data and records of the output made by said output means, in a state in which they are correlated with one another;
said information center apparatus comprising:
receiving means for receiving secondary conversion data transmitted from said information management apparatus; and
decryption means for decrypting secondary conversion data received by said receiving means to generate said primary conversion data.

7. An information management system as recited in claim 6, wherein said information center apparatus further comprises data storage means for storing primary conversion data generated by said decryption means and processes data stored in said data storage means by means of said unique code as a key.

8. An information management system as recited in claim 7, wherein said information center apparatus detects data containing the same unique code from a plurality of data containing said unique codes stored in said data storage means.

9. A program for causing an information management computer for processing data containing personal data to execute processing comprising the steps of:
extracting personal data from processing-object data by means of personal data extraction means,
performing an operation using a one-way function on the basis of the personal data extracted by said personal data extraction means by means of unique code generation means to generate a unique code, and
replacing personal data of said processing-object data with said unique code by means of primary conversion data generation means to generate primary conversion data.

10. The program of claim 9, which is for causing said information management computer to execute the processing which further comprises the step of storing said primary conversion data and said processing-object data as an origin of said primary conversion data in storage means in a state in which they are correlated with each other.

11. The program of claim 9, wherein the step of generating the unique code by said unique code generation means comprises the steps of:
generating a reference character string from personal data, which are extracted by said personal data extraction means, by means of a reference character string generation means; and
operating a predetermined operation-object character string by means of said one-way function using said reference character string as a key to generate said unique code.

12. The program of claim 11, wherein the step of generating said unique code with said operation means comprises the steps of:
determining an operation digit number on the basis of said reference character string by means of digit number determination means;
generating an operation-object character string having said operation digit number by means of operation-object character string generation means; and
operating said operation-object character string by means of said one-way function by operation execution means using said reference character string as a key.

13. The program of claim 9, which is for causing said information management computer to execute the processing which further comprises the steps of:
encrypting said primary conversion data by means of secondary conversion data generation means to generate secondary conversion data;
outputting said secondary conversion data to other apparatus by output means;
and causing storage means, when said secondary conversion data are outputted from said output means, to store said outputted secondary conversion data, said primary conversion data as an origin of said secondary conversion data, said processing-object data as an origin of said primary conversion data and records of the output from said output means, in a state in which they are correlated with one another.
